(19) United States
(12) Patent Application Publication
(10) Pub. No.: US 2012/0268913 A1
(43) Pub. Date: Oct. 25, 2012

(54) FLASH UNIT DIFFUSER WITH WINGS

(76) Inventors: Dana Ng, West Covina, CA (US); Han Li, West Covina, CA (US)

(21) Appl. No.: 13/092,865

(22) Filed: Apr. 22, 2011

(51) Int. Cl. G03B 15/02

(52) U.S. Cl. 362/18

(57) ABSTRACT

A light diffuser for use on a camera strobe/flash unit either on camera or off. The diffuser has a main body with a base and is composed of a non-transparent material. The diffuser splits the single light source into two directions sending light into a pair of wings/cowls that are removably mounted to the main body. Inside the diffuser main body is a light-splitting reflector with a reflective surface to add an amount of specular and focused light towards the two cowls. The wings/cowls create two soft light sources. Further, the wings/cowls may have other shapes, colors, features such as holes, outlets, etc., to create additional light sources of soft light. The wings/cowls may also be colored to adjust the projected diffused light therefrom. The base of the half-cylindrical main body may include a plurality of contact arms adapted to grip the photographic light source.

### CROSS REFERENCES TO RELATED APPLICATIONS

NA

### REFERENCE TO FEDERALLY SPONSORED RESEARCH OR DEVELOPMENT

NA

### REFERENCE TO JOINT RESEARCH AGREEMENTS

NA

### REFERENCE TO SEQUENCE LISTING

NA

### BACKGROUND OF THE INVENTION

1. Field of the Invention

The present invention relates generally to photographic light systems, and, in particular, relates to lights systems for use with strobes, and, in greater particularity, relates to a diffuser for use on strobes.

2. Description of the Prior Art

The use of additional light sources in photography is well known. One such source of light is a strobe. Although the strobe does produce additional light, this light is direct and can produce high contrast scenes with sharp shadows. The use of diffusers attached to the strobe helps reduce the high contrast.

Also, hot-spots on the subject are created by direct lighting, where some areas are too saturated with light. In instances where harsh shadows and hot-spots are not desirable, a light-diffusing accessory is used to provide a soft lighting effect. In other cases, even more indirect light is needed to create a balanced lighting effect. In these cases, light-diffusing accessories help in redirecting the light to bounce from the ceiling and walls to create more indirect light onto the subject.

To create a softer light, direct light can be passed though a semi-transparent diffusion material that scatters the light in different directions. This effect may also be achieved by casting light onto a reflective material. Still photographers may choose to use multiple diffusers positioned at different angles around the subject to create more indirect light. This can be done with umbrellas, soft boxes and the like.

There are many known small portable diffusers that attach onto photographic strobes and are portable enough for use outside of a studio setting. However, many of these known small portable diffusers rely upon ceiling bounces to create indirect light. In areas that lack ceilings, these known small portable diffusers do not provide enough indirect light to adequately reduce shadows and hotspots.

For example, whether on-camera to the hot shoe or to a bracket, or off-camera, strobes typically have a variety of plastic diffusers for attachment to the strobe lens. These typically snap on to the strobe lens. Color correction or addition can be had with gel films cut to fit over the strobe lens.

One type of stand-alone diffuser is the umbrella. The multiple reflective panels create multiple sources of light to create a soft lighting effect.

Another diffuser for attachment to the strobe head is a soft box or a hard box device. The head of the strobe fits into an opening and may be held there by straps, an elastic band in the opening border or by a flexible opening. For example, U.S. Patent Application 2008/0310140 shows a light box being a hard box device. The flash head fits into a back opening. Reflectors, shields, and color filters can further be attached to the light box. See U.S. Pat. No. 7,810,941. U.S. Patent Application 2008/0259588 shows a cowl-shaped device with a removable front cover. A flexible opening is used to attach this to the light head of the strobe as shown in FIG. 9. U.S. Pat. No. 6,683,719 shows a soft box diffuser where it is an inflatable sack attached to the light head. U.S. Pat. No. 5,154,503 shows a frame covered with a flexible semi-transparent material attached to the light head. To create additional light sources, U.S. Pat. No. 4,441,141 shows a light reflector unit attached to a camera for use with a camera flash. The reflector unit divides the light into two beams that are parallel the lens. The outlets may have diffusers positioned thereon.

Accordingly, there is an established need for a diffuser having the ability to produce multiple light sources that provides a softer light source from multiple directions.

### SUMMARY OF THE INVENTION

The present invention is directed at a portable diffuser that splits strobe light into two or more diffused light sources before lighting the subject providing a superior soft lighting effect.

The invention is light diffuser for a camera strobe/flash unit either on camera or off. The diffuser has a main body with a base being composed of a non-transparent material that splits the single light source into two directions sending light into a pair of wings/cowls that are removably mounted to the main body. The main body may have the shape of a half cylindrical upper body in one embodiment. Inside the diffuser main body is a light-splitting reflector with a reflective surface to add an amount of specular and focused light towards the two cowls. The wings/cowls may be made of a semi-transparent material to produce two soft light sources. The wings/cowls are removably attached to the main body. Further, the wings/cowls may have other shapes, colors, features such as holes, outlets, etc., to create additional light sources of soft light. The wings/cowls may also be colored to adjust the projected diffused light therefrom. The base of the half-cylindrical main body may include a plurality of contact arms adapted to grip the photographic light source such as the top frame of a strobe.

An object of the present invention is to provide a means for outputting soft light from a photographic light source.

It is another object of the present invention to provide a means for outputting soft light from a plurality of outlets.

It is a further object of the present invention to provide a means for outputting both soft light and direct light from a plurality of outlets.

It is still a further object of the present invention to provide a means for outputting light, diffuse light, from a strobe, flash unit, either on or off camera.

It is yet a further object of the present invention to provide a means for outputting light that is easily adaptable to a strobe unit flash output head.

It is yet a further object of the present invention to provide a means for outputting diffuse light from a strobe that substantially eliminates and/or removes shadows.

It is yet a further object of the present invention to provide a means for outputting light that is easily adaptable to a strobe unit flash output head, but has easily attached wings/cowls.

It is a further object of the present invention to provide a diffuser that eliminates the need to carry around lighting equipment such as brackets, umbrellas, soft boxes and the like.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is front view of a strobe with a wing diffuser thereon of a preferred embodiment of the present invention;

FIG. 2 is a perspective view of the wing diffuser of the present invention without the strobe as shown in FIG. 1;

FIG. 3 is a top view of the wing diffuser of FIG. 2;

FIG. 4 is a side view of the wing diffuser of FIG. 2;

FIG. 5 is a bottom view of the wing diffuser of FIG. 2;

FIG. 6 is a front perspective view of a wing diffuser having wing diffuser elements or wings, before attachment, to a strobe wherein the flash head is turned perpendicular to the strobe main body so as to present the wings in a horizontal mode wherein the directed light is parallel the floor;

FIG. 7 is a front perspective view of the wing diffuser of FIG. 6 showing the wings after attachment to the flash head of the strobe;

FIG. 8 is a front perspective view of the wing diffuser of FIG. 6 showing the wings attached, but in a vertical position; and

FIG. 9 is a front and side view of another embodiment of a wing of the present invention wherein an light outlet is provided by a specular back portion of the wing;

FIG. 10 is a front view of a ring wing of the present invention wherein a circular light channel has a semi-transparent front wall and a reflective back wall; and

FIG. 11 is an unfolded top view of the wing diffuser of the present invention.

Like reference numerals refer to like parts throughout the several views of the drawings.

### DETAILED DESCRIPTION OF THE PREFERRED EMBODIMENTS

The present invention is directed at a flash unit diffuser that allows photographers to achieve studio-quality lighting using electronic photographic flashes without the need for separate lighting equipment.

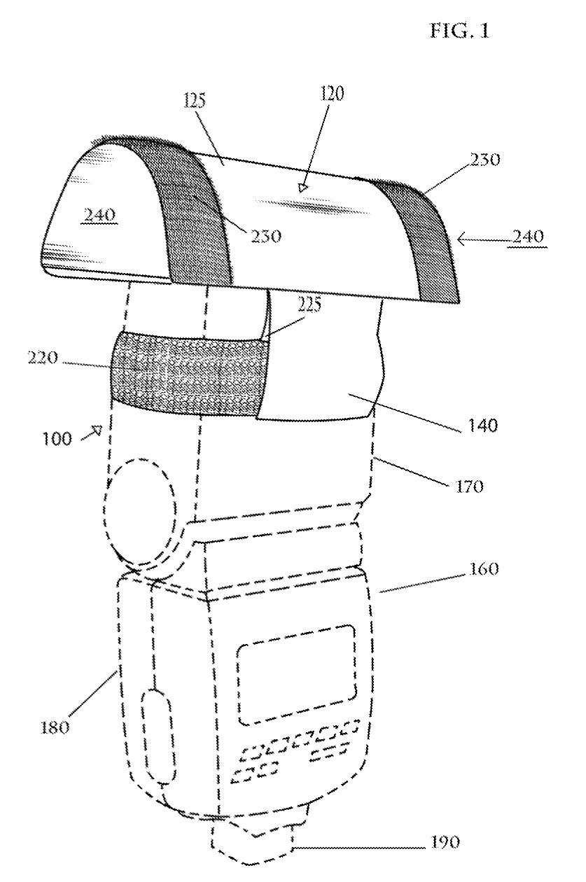

Turning to the drawings, wherein like components are designated by like reference numerals throughout the various figures, attention is initially directed to FIG. 1 which illustrates a perspective view of a flash unit diffuser 100 constructed according to the present invention.

As best shown in FIG. 1, the diffuser 100 has a main body 120 with an upper housing 125. Attached to the upper housing 125 is a plurality of attachment fingers 140, typically two (2), that can be attach to the flash unit 160 having a flash head 170 rotatably mounted to body 180 with a hot shoe connector 190 thereon that may be connected to a hot shoe that is commonly available on certain cameras. These fingers 140 provides means for removably attaching the diffuser 100 to the flash unit 160, with light from the flash unit 160 passing into the upper housing 125 directly.

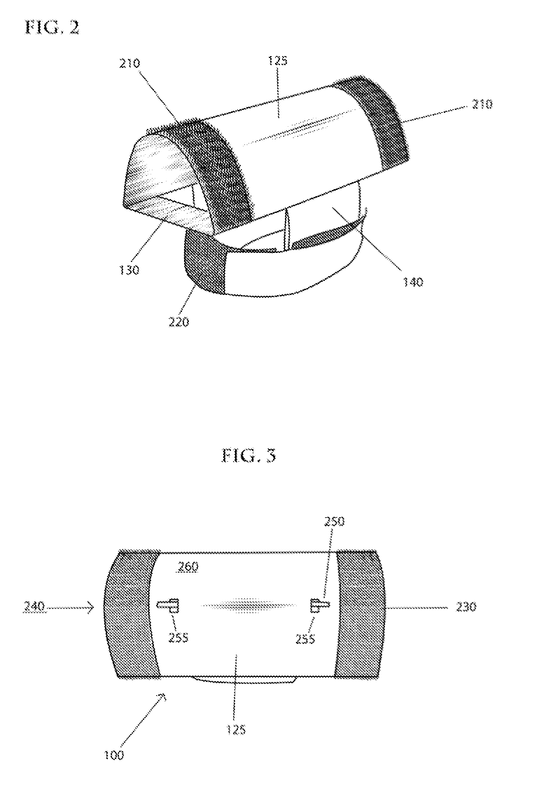

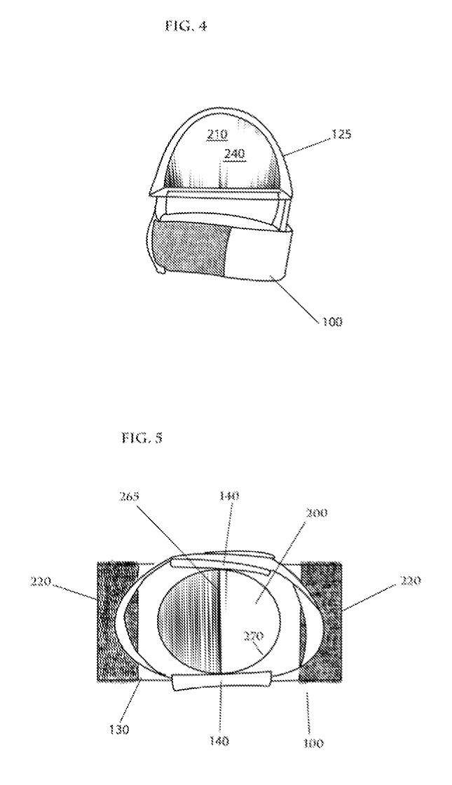

Inside the main body 120 are two angled mirrors 200, FIGS. 4 and 5, that split the light from the flash head 170 into two branches 210, FIG. 2, of the main body 120 and upper housing 125. FIG. 2 also shows a bridge section 130 formed at the bottom of light outlets 240 that provides support to the strap 230 and further holds the upper housing 125 in the half cylindrical shape shown. As will be shown below, other attachments may be connected to the main body 120 by means of Velcro® straps 230 that are attached about light outlets 240, two in the present embodiment.

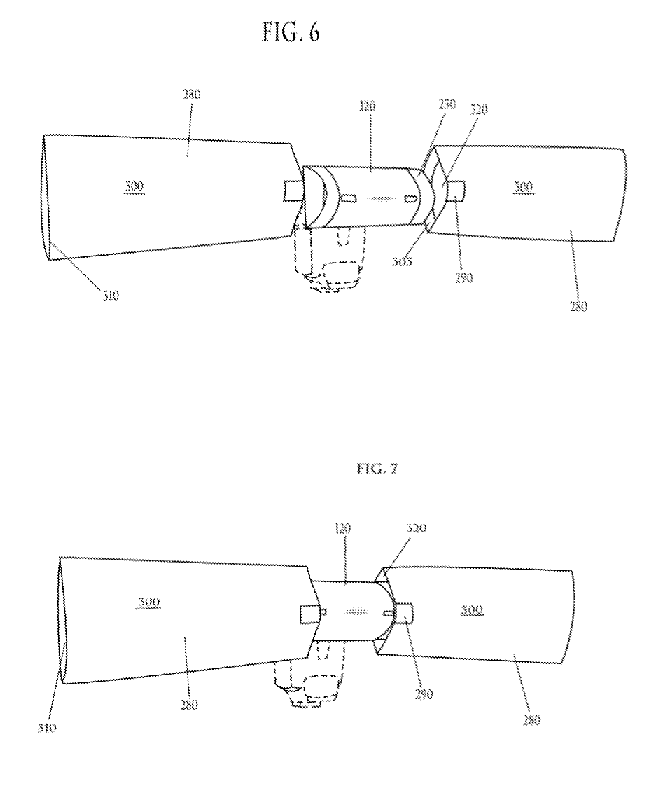

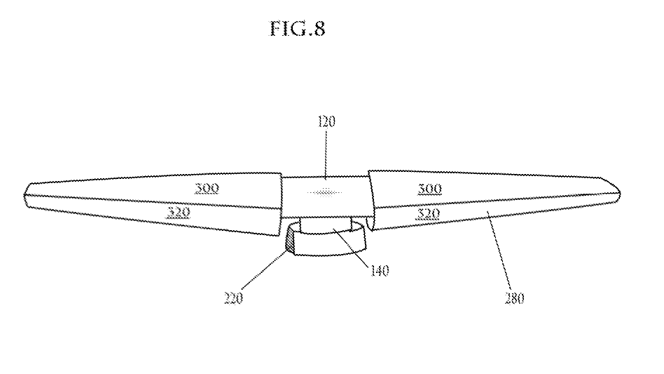

The present diffuser 100 is shown, wherein a half cylindrical upper housing 125 is generally symmetric with respect to an axis extending along the direction of the flash unit 160 on which the diffuser 100 is mounted. The upper housing may have other shapes, but these shapes must provide for holding mirrors 200 or the like and channeling light therefrom to light outlets 240. The upper housing 125 may be composed of plastic or metal or a combination material known in the art. In this embodiment, the half cylindrical upper housing 125 of the diffuser 100 may be reflective with the two angled mirrors 200 flaring outwards from the center vertex 265, FIG. 5, which directs light outwards to the two light outlets 240 in the opposite ends of the upper housing 125. Clearly, the light outlets 240 need not be opposite each other since the upper housing 125 guides the light to these outlets directly or by internal reflection. These angled mirrors 200 help to direct light which would otherwise cause the majority of the light to reflect backwards towards the photographic flash and thus reducing light output towards the two light outlets 240. While some direct lighting effect is desired as discussed above, it can be provided more evenly and reliably by wings 280, FIGS. 6 to 9, and as such it is desirable in this embodiment shown to emphasize the diffuse lighting function of the wings 280 at the expense of the direct lighting function. With the present diffuser 100 and the two attached wings 280, the softness of the lighting effect produced comes as much if not more so from the shape of the two wings 280 itself and especially the manner in which light is evenly refracted through the surface of the wings 280 as from the dispersal of light around the room, including light reflected by the walls and ceilings simultaneously. Although in the preferred embodiment wings 280 are shown attached to the diffuser 100, the diffuser 100 also provides indirect lighting from the two light outlets 240 without the two wings 280.

Although this is a preferred embodiment, there are clearly other configurations and materials that would function equally well. For example, the attachment fingers 140 may fit directly over the flash head 170 without further support, or a Velcro® strap 220 may be used about the fingers 140, or a threaded collar, or a bayonet style mount, or other appropriate devices known to those skilled in the art. As seen in FIG. 1, the strap 220 passes through an opening section 225 formed when the finger 140 is bent back and upwards as will be shown. The main body 120 and the fingers 140 may be integrally formed of plastic or metal or a combination, or may be separately formed and then glued together. These parts are typically made of non-transparent plastic or like materials.

FIG. 3 is a top view of the diffuser 100. As seen therein, a pair of hooks 250 protrudes through a top 260 of the main body 120. The mirrors 200 are hinged at a vertex 265, FIG. 5, and FIG. 4 shows by end view one hollow channel/branch 210 with a mirror 200 therein. FIG. 5 shows by a bottom view, the pair of mirrors 200 in the upper housing 125 with a pair of fingers 140 and the pair of Velcro® straps 220 thereabout. Light from the flash unit enters into an opening 270 in the bottom.

As seen in FIG. 1, diffuser 100 has the pair of branches 210 that extend beyond the flash head 170. The light from the flash head 170 will thus be diverted in a direction substantially perpendicular to the flash head light forming two light sources. The extension of the channels 210 provides for a larger and more diffuse light source with the use of two “wings” or “cowls” attached to the branch ends as will be further shown.

To provide for greater flexibility, FIGS. 6 to 9 illustrate the wings 280 with different orientations and/or different features. These wings 280 are removably attached to the main body 120 by means of Velcro® tabs 290 as will be shown. Since the Velcro® strips 230 circumscribe the light outlets 240, the wings 280 can be oriented in any direction by moving the tabs 290 to another position thereon. The wings 280 provide a light channel between a light inlet 305 and a wing outlet 310.

FIG. 6 illustrates two wings 280 before attachment to the main body 120 of the diffuser 100. Velcro® tabs 290 on the inside of the wings 280 are used to attach the wings to the main body strips 230 being of an opposite type of attachment means than tabs 290 as is known in the art. The wings 280 may be open at both ends with outlet 310 or may be closed. The cowl or wing 280 is made of a semi-transparent material on at least a front face 300 thereof. The back wall 320 may have reflective coating thereon. Both the front wall/face 300 and back wall 320 can be made from a plastic material and when not in use on the main body 120 are flat and can be easily stored and transported in a camera bag. A photographer carrying many different diffusers can stack them for ease in storage and transport. In yet another embodiment, the diffuser 100 and two wings 280 are proportioned so that it is easy to pack and transport in that it may be placed in a photographic flash department when packed together with a camera in a standard camera/gadget bags, thus saving space. For example, two wings 280 of the diffuser 100 may be folded and slipped in along side of the photographic strobe compartment of a camera bag and the diffuser 100 may be placed directly in the photographic flash compartment next to the two folded wings 280. In this way, the parts of the diffuser nest within each other in a compact arrangement.

The light from the outlets 310 will normally bounce from nearby surfaces such as walls, floors, ceilings, and then onto the subject. As a result of the bounces, multiple sources of light are created and thus eliminate shadows on the subject which are especially noticeable when the subject is near a wall as provided by the general flash unit without the present invention.

The lighting properties of the diffuser 100 can be varied by varying the relative proportions of its length and width. Specifically, the length and width of the channels through the generally wing 280 can be varied with respect to the size of the channel through the main body 120 that is fixed. A longer passage and a larger rectangular element 280 would cause the diffuser 100 to provide less of a direct and more of diffused lighting effect. The length is typically two or three times longer than the width. Fill light is desirable to provide an amount of specular light by bouncing off of nearby surfaces for an exposed image. The higher intensity gives more of a warp around effect and prevents the background of the subject from appearing excessively dark. The softness of the lighting effect produced comes as much if not more so from the shape of the wings 280 and especially the manner in which light is evenly refracted through the surface of the wings 280 as from the dispersal of the light around the room, including light reflected by the walls and the ceilings simultaneously.

In one embodiment, the half cylindrical upper housing 125 of the diffuser 100 allows it to provide similar lighting effects when used in either the horizontal position, FIGS. 6 and 7, or vertical position, FIG. 8. Accordingly, unlike prior diffusers, no flash bracket is needed with the present diffuser 100 to keep the flash in position during both vertical and horizontal photography. In one embodiment, the height and width of the wing are about equal to one another. In another embodiment, the diffuser is generally square in shape, and in another embodiment is generally rectangular in shape.

When shooting with the diffuser in a horizontal position in environments with ceilings and walls, the diffuser 100 and two attached wings 280 can shoot directly as shown in FIG. 6. Otherwise when shooting in a horizontal position in environments with ceilings, the diffuser 100 and two attached wings 280 can be aimed directly into the ceiling for a ceiling bounce and wall bounce effect. This gives a great lighting ratio for shots taken with the diffuser in the vertical position, reducing shadows on the subject and giving a diffuse, soft light all around the room as well as on the subject. For large group shots, the lighting quality is soft, beautiful and diffused. The open top allows a great deal of light to bounce off the ceiling onto the subject yielding a beautiful, natural lighting effect.

FIG. 7 shows the wing diffuser elements 280 in the horizontal position with the wings 280 attached to the main body 120 by Velcro® means or similar devices or means.

FIG. 8 shows the wings 280 in the vertical position with the wings 280 attached to the main body 120 by Velcro® means as in FIG. 7.

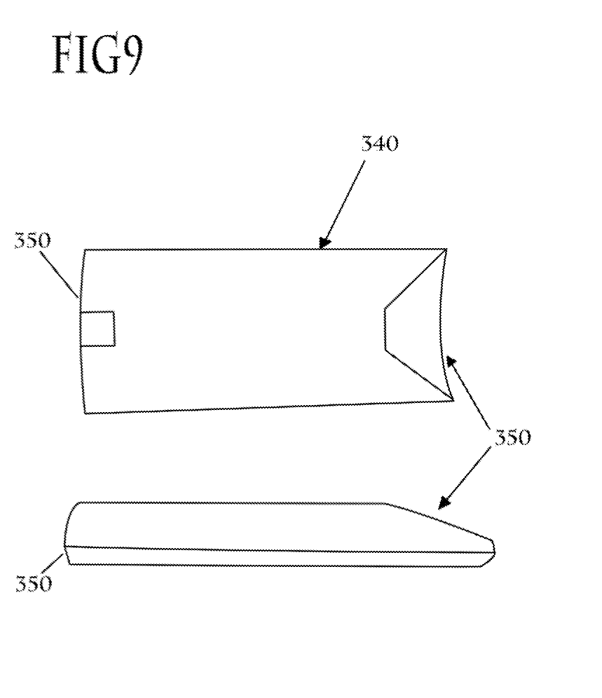

FIG. 9 shows a wing 340 having a specular light outlet 350 at the end of the wing 340. The top picture being a top view and the bottom picture being a side view.

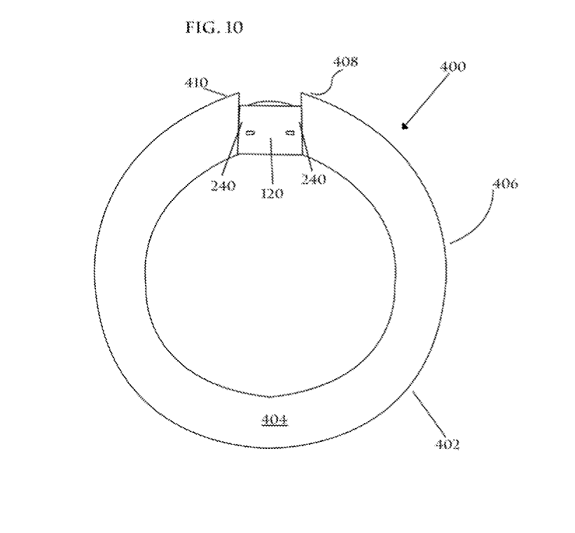

FIG. 10 illustrates a ring wing 400. The ring wing 400 forms a light channel 402 of semi-circular shape as seen in FIG. 9. It has a semi-transparent front wall 404 and a reflective back wall 406. The ring wing 400 is made of a flexible material and constructed similarly to the above wings 280 wherein the front wall 404 and the back wall 406 are attached together. It has a first light inlet 408 and a second light inlet 410 that are attached as above, respectively, to the light outlets 240 on the main body 120. The ring light 400 wraps light around the subject in a circular fashion eliminating most shadows and leaving a halo effect as the subject's background shadow.

On occasion, photographers will want the reflected light in their shots to have a particular color quality. This can be provided with alternative embodiments of the present diffuser's wing 280 wherein the material of the entire diffuser itself, or specific portions of the diffuser such as the wing or the base are formed having a particular hue. For example, the wing 280 can be made amber for inside shots to match the overall warming lighting effect in florescent lighting. The diffuser 100 and wing 280 can be tinted with amber or another color to vary the color and intensity of the light on the subjects of the photograph.

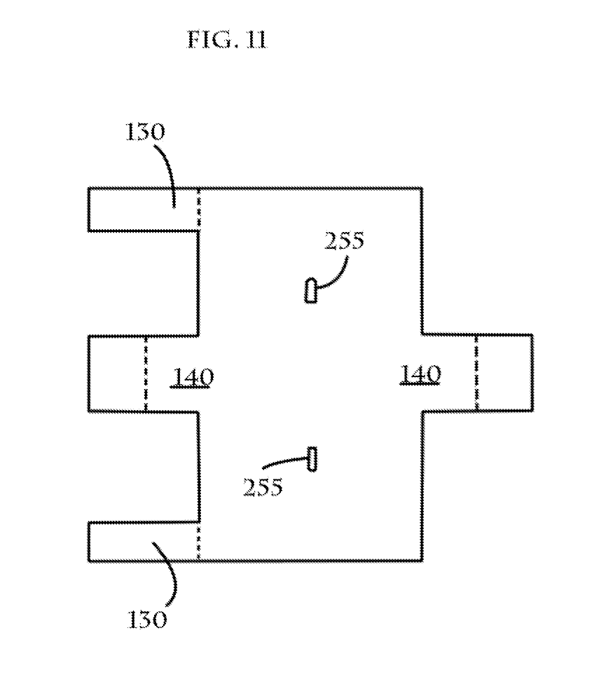

FIG. 11 is an unfolded top view of the wing diffuser of the present invention. In this embodiment, the diffuser 100 is composed of sheet metal such as aluminum which is easily cut and folded. The upper housing 125 is rectangular in shape with the two hook openings 255 therein. Integrally attached to the center are two fingers 140 which are folded at the dotted line thereon to produce the opening 225 as shown in FIG. 1. Attached on one side are two bridges 130 that are folded at the dotted line thereon and attached to the opposing side to form and hold the half-rectangular shape of the upper housing 125 as seen in FIG. 1 et seq. This is only one illustration of the making of the diffuser 100. Other possible techniques, materials, and features are clearly possible when one is knowledgeable of the present invention and this example should not be limited in scope. The wing itself may be made of plastic-like materials having the features noted. It may be cut from one piece and then folded into the shapes shown and glued together.

Since many modifications, variations, and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A diffuser for a flash unit, said diffuser comprising:
a main body, said main body having removable attachment means for connection to the flash unit, said main body having means therein for splitting a light from the flash unit into a plurality of light sources, and light outlet means on said main body for outputting light from the means for splitting light into the plurality of light sources, said light sources outputting light in a direction substantially opposing each other.

2. The diffuser for a flash unit as recited in claim 1, wherein said means therein for splitting the light is two or more mirrors, each mirror being the light sources.

3. The diffuser for a flash unit as recited in claim 2, wherein the mirrors are mounted at about 90 degrees from other, each mirror being mounted at about 45 degrees from the light from the flash unit.

4. The diffuser for a flash unit as recited in claim 2, wherein said mirrors are mounted in an upper housing, said upper housing having the light outlet means.

5. The diffuser for a flash unit as recited in claim 4, wherein said upper housing is substantially half-cylindrical shaped.

6. The diffuser for a flash unit as recited in claim 5, wherein an end of said half-cylindrical shaped upper housing is one light outlet.

7. The diffuser for a flash unit as recited in claim 6, wherein said end has means thereon for removably mounting a wing or cowl element.

8. The diffuser for a flash unit as recited in claim 7 wherein said half-cylindrical upper housing has two light outlets.

9. The diffuser for a flash unit as recited in claim 8, wherein one or more wings are removably mounted to said light outlets.

10. The diffuser for a flash unit as recited in claim 9, wherein there are two wings elements on said diffuser.

11. The diffuser for a flash unit as recited in claim 10, wherein said wing has a proximal end for removably mounting to said light outlet on said main body, said wing has a distal end, wherein said proximal end and said distal end are connected together by a wall material providing a light channel therebetween.

12. The diffuser for a flash unit as recited in claim 11, wherein said wall material is partially reflective.

13. The diffuser for a flash unit as recited in claim 11, wherein said wall material is partially semi-transparent to light.

14. The diffuser for a flash unit as recited in claim 11, further including one or more additional light outlets in said wing.

15. The diffuser for a flash unit as recited in claim 8, further including a ring wing wherein said ring wing has proximal ends with light inlets for removably mounting to said light outlets on said main body, said ring wing having a semi-circular light channel between said light inlets.

16. The diffuser for a flash unit as recited in claim 1, wherein said removable attachment means comprises two or more fingers attached to said main body.

17. The diffuser for a flash unit as recited in claim 4, wherein said upper housing is not transparent to light.

18. The diffuser for a flash unit as recited in claim 16, further including a strap to hold said two or more fingers on the flash unit.

19. A diffuser for a flash unit, said diffuser comprising:
a main body, said main body having removable attachment means for connection to the flash unit, said removable attachment means being two or more fingers attached to said main body, said main body having means therein for splitting a light from the flash unit into a plurality of light sources, and light outlet means on said main body for outputting light from the means for splitting light into the plurality of light sources; and
one or more wings or cowl elements, said wing or cowl elements removably mounted to said light outlet means of said main body.

20. The diffuser for a flash unit as recited in claim 19, wherein a wall material of said wing or cowl element is partially reflective.

21. The diffuser for a flash unit as recited in claim 19, wherein a wall material of said wing or cowl element is partially semi-transparent to light.

22. A method for providing diffuse light from a flash unit, said method comprising the steps of:
removably attaching a diffuser having two more light outlets; and
providing the diffuser with two or more light splitting means.

23. The method for providing diffuse light as recited in claim 22, further including the step of removably mounting one or more wings to the light outlets of the diffuser.
